(19) United States
(12) Patent Application Publication
(10) Pub. No.: US 2025/0233801 A1
(43) Pub. Date: Jul. 17, 2025

(54) CONTROL DEVICE AND BASE-STATION CONTROL METHOD

(71) Applicant: Fujitsu Limited, Kawasaki-shi (JP)

(72) Inventor: Shinya YAMAMURA, Fukuoka (JP)

(73) Assignee: Fujitsu Limited, Kawasaki-shi (JP)

(21) Appl. No.: 18/977,271

(22) Filed: Dec. 11, 2024

(30) Foreign Application Priority Data
Jan. 17, 2024 (JP) 2024-005658

(51) Int. Cl. H04L 41/147; H04W 52/02

(52) U.S. Cl. CPC H04L 41/147; H04W 52/0206

(57) ABSTRACT

A control device includes, a predictor that predicts group traffic of a group including a plurality of base-station devices, with use of respective amounts of individual traffic of the plurality of base-station devices, and a controller that determines whether to stop or operate a base-station device in the group, in accordance with the predicted group traffic, wherein the group includes a base-station device that forms a macro-cell and a base-station device that forms a small cell, and the small cell includes a region overlapping the macro-cell.

### CROSS-REFERENCE TO RELATED APPLICATION

This application is based upon and claims the benefit of priority of the prior Japanese Patent Application No. 2024-005658, filed on Jan. 17, 2024, the entire contents of which are incorporated herein by reference.

### FIELD

The present invention relates to a control device and a base-station control method.

### BACKGROUND

In a wireless communication system, base-station devices are optimally installed depending on its communication traffic amount, leading to achievement of power saving of the communication system. In addition, switch-off processing is performed to keep some base-station devices stopped for a certain period depending on the communication traffic amount, leading to achievement of further power saving.

In order to continue stable communication services despite such switch-off processing in the wireless communication system, for example, a base-station device to be stopped is determined, on the basis of traffic demand prediction per base-station device.

Techniques regarding traffic prediction are described, for example, in Japanese Patent Application Publication No. 2013-247563 and WO 2014/057812.

### SUMMARY

According to an aspect of the embodiments, a control device includes a predictor that predicts group traffic of a group including a plurality of base-station devices, with use of respective amounts of individual traffic of the plurality of base-station devices, and a controller that determines whether to stop or operate a base-station device in the group, in accordance with the predicted group traffic, wherein the group includes a base-station device that forms a macro-cell and a base-station device that forms a small cell, and the small cell includes a region overlapping the macro-cell.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary configuration of a wireless communication system 10.

FIG. 2 illustrates an exemplary configuration of the server machine 300.

FIGS. 3A and 3B illustrate an exemplary relationship between measured traffic and predicted traffic.

FIG. 4 illustrates an exemplary processing flowchart of switch-off processing S100.

FIG. 5 illustrates an exemplary sequence of switch-off processing.

FIG. 6 illustrates exemplary groups.

FIGS. 7A and 7B illustrate exemplary groups.

FIG. 8 illustrates exemplary group predicted traffic sorting.

### DESCRIPTION OF EMBODIMENTS

Regarding a base-station device kept stopped due to switch-off processing, the traffic of the corresponding cell in switch-off is zero and part of traffic data as an input for prediction is missing. Thus, traffic demand prediction is difficult to perform with high accuracy.

Regarding a base-station device in operation despite switch-off processing, concentration of traffic due to other terminal devices in other cells causes data as an input for prediction to be larger in amount than in normal operation. Thus, traffic demand prediction is difficult to perform with high accuracy.

### First Embodiment

A first embodiment will be described.

### Wireless Communication System 10

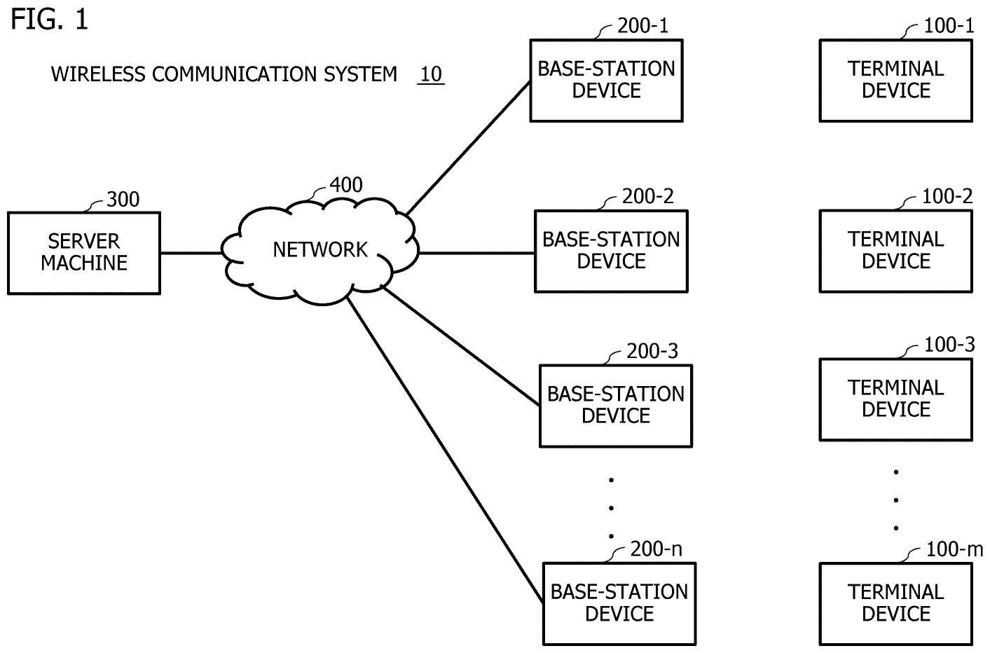

FIG. 1 illustrates an exemplary configuration of a wireless communication system 10. The wireless communication system 10 includes terminal devices 100-1 to 100-m (m is an integer), base-station devices 200-1 to 200-n (n is an integer), a server machine 300, and a network 400. The wireless communication system 10 serves as a communication system to which switch-off processing is applied. The switch-off processing is, for example, processing of predicting a communication amount (hereinafter, also referred to as traffic) between the base-station devices 200-1 to 200-n (hereinafter, also referred to as base-station devices 200) and the terminal devices 100-1 to 100-m (hereinafter, also referred to as terminal devices 100) and then keep some base-station devices stopped for a predetermined period depending on the prediction result.

The terminal devices 100 each serve as a communication device that performs wireless communication in wireless connection with a base-station device 200. For example, the terminal devices 100 are each a tablet terminal or a smartphone. The terminal devices 100 each perform wireless communication in wireless connection with a base-station device 200 that forms a destination cell (namely, a communication area formed by base-station devices 200).

The base-station devices 200 each serve as a communication device that performs wireless communication in wireless connection with a terminal device 100. For example, the base-station devices 200 are each eNodeB or gNodeB. The base-station devices 200 each perform wireless communication with a terminal device 100 or a communication relay between a terminal device 100 and a different communication device. The base-station devices 200 each transmit, as a relay, a signal received from the terminal device 100 to the target communication device through the network 400 in connection.

The server machine 300 serves as a device that performs switch-off processing (issues an instruction) and is, for example, a computer or a server machine. The server machine 300 collects the traffic from the base-station devices 200. With the collected traffic, the server machine 300 performs traffic prediction. The server machine 300 determines a base-station device 200 to be stopped, in accordance with the traffic prediction and then instructs the 10) base-station device 200 to stop.

The network 400 serves as a network that mediates communication between the server machine 300, the base-station devices 200, and different communication devices, and is, for example, the Internet or an intranet.

In the wireless communication system 10, for traffic prediction, not only the traffic of each base-station device 200 but also the traffic of a group unit including a plurality of base-station devices 200 is predicted. For determination of a base-station device 200 to be stopped in switch-off processing, not only the traffic prediction of each individual base-station device 200 but also the traffic prediction of each group is used.

### Exemplary Configuration of Server Machine 300

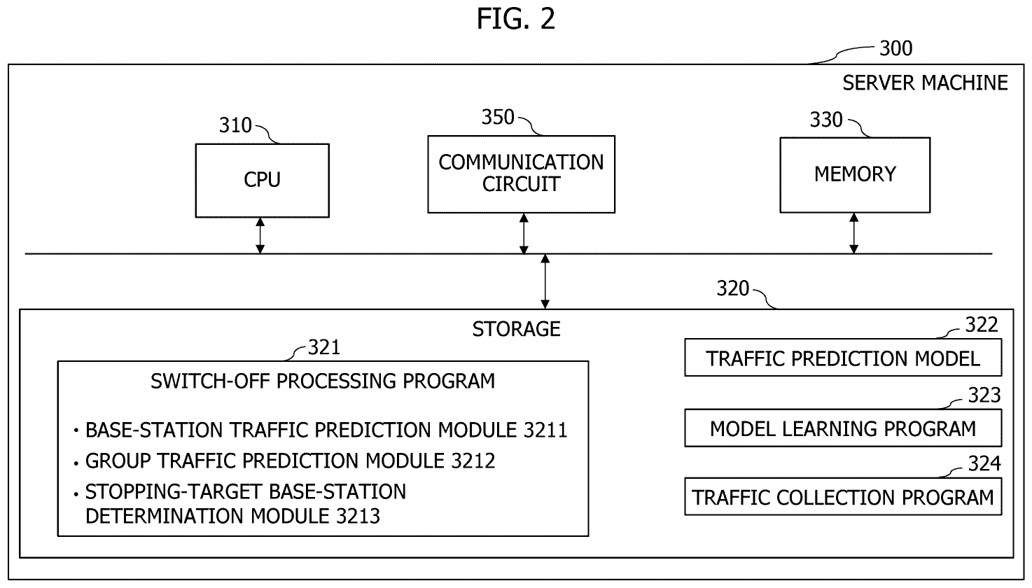

FIG. 2 illustrates an exemplary configuration of the server machine 300. The server machine 300 includes a central processing unit (CPU) 310, a storage 320, a memory 330, and a communication circuit 350.

The storage 320 serves as an auxiliary storage device, such as a flash memory, a hard disk drive (HDD), or a solid state drive (SSD), that stores a program or data. The storage 320 stores a switch-off processing program 321, a traffic prediction model 322, a model learning program 323, and a traffic collection program 324.

The traffic prediction model 322 serves as an artificial intelligence (AI) learning model that predicts traffic per base-station device 200. The traffic prediction model 322 is, for example, a trained model having learnt, as supervised data, the communication amount per period of time (per predetermined time) of each base-station device 200 and a feature regarding the communication amount. With the traffic prediction model 322, the server machine 300 can predict the traffic at a period of time of a base-station device 200.

The memory 330 serves as an area to which a program stored in the storage 320 is loaded. The memory 330 may be used for an area into which a program stores data.

The communication circuit 350 serves as a device that performs communication with each base-station device 200 or a different communication device by transmission or reception of a packet, and is, for example, a network interface circuit. The communication circuit 350 performs communication with each base-station device 200 or acquires a packet transmitted or received through the network 400.

The CPU 310 serves as a processor that loads a program stored in the storage 320 into the memory 330 and executes the loaded program to establish the corresponding unit for achievement of the corresponding processing.

The CPU 310 executes the switch-off processing program 321 to establish a prediction unit and a control unit to perform switch-off processing. The switch-off processing corresponds to processing of performing traffic prediction per base-station device 200 and additionally performing traffic prediction per group to determine a base-station device 200 to be stopped from the group traffic prediction and cause the base-station device 200 to stop. The performance of the switch-off processing enables suppression of the power of the base-station devices 200, leading to achievement of power saving.

The CPU 310 executes a base-station traffic prediction module 3211 in the switch-off processing program 321 to establish a prediction unit to perform base-station traffic prediction processing. The base-station traffic 30 prediction processing corresponds to processing of predicting traffic per base-station device 200. For example, with the traffic prediction model 322, the server machine 300 predicts the traffic of each base-station device 200. The switch-off processing may include, for example, processing of classifying the base-station devices 200 into groups. The base-station devices 200 belonging to the groups may be stored in the memory 330 due to advance determination or may be determined as part of the switch-off processing.

The CPU 310 executes a group traffic prediction module 3212 in the switch-off processing program 321 to establish a prediction unit to perform group traffic prediction processing. The group traffic prediction processing corresponds to processing of predicting traffic per group. For example, the server machine 300 sums up the respective amounts of traffic of a plurality of assigned base-station devices 200 per group to predict traffic per group. In a case where the traffic prediction model 322 enables traffic prediction per group, with the traffic prediction model 322, the server machine 300 may predict traffic per group.

The CPU 310 executes a stopping-target base-station determination module 3213 in the switch-off processing program 321 to establish a prediction unit and a control unit to perform stopping-target base-station determination processing. The stopping-target base-station determination processing corresponds to processing of determining a base-station device 200 to which switch-off processing is to be performed, in accordance with the predicted traffic per group or the predicted traffic per base-station device. For example, on the basis of the predicted traffic per group, the server machine 300 selects a group that allows switch-off and determines, as the stopping-target base station, any or some of the base-station devices 200 in the group.

With the traffic prediction model 322, the CPU 310 performs traffic prediction processing. The traffic prediction model 322 is, for example, a trained model having learnt, as supervised data, the traffic of each base-station device 200. The traffic prediction processing is, for example, processing of predicting traffic per base-station device 200. Note that, in a case where the traffic prediction model 322 has learnt, as supervised data, the traffic of each group, the traffic prediction processing corresponds to processing of predicting traffic per group. Hereinafter, unless otherwise specified, the traffic prediction processing corresponds to processing of predicting traffic per base-station device 200.

The CPU 310 executes the model learning program 323 to establish a learning unit to perform model learning processing. The model learning processing corresponds to processing of causing the traffic prediction model 322 to learn. The server machine 300 performs the model learning processing with the traffic of each base-station device 200 as supervised data.

The CPU 310 executes the traffic collection program 324 to establish a collection unit to perform traffic collection processing. The traffic collection processing corresponds to processing of collecting the traffic from each base-station device 200 and is regularly performed, for example. The server machine 300 sorts the collected amounts of traffic corresponding to the base-station devices 200 and then stores the sorted amounts of traffic into an internal memory. Then, with the stored traffic, the server machine 300 causes the traffic prediction model 322 to learn.

### Traffic Prediction

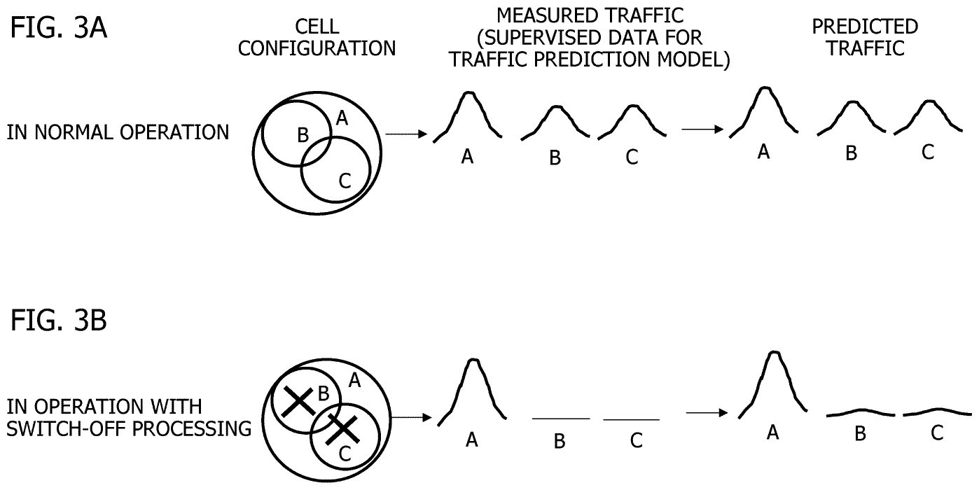

Traffic Prediction will be described. FIGS. 3A and 3B illustrate exemplary relationships between practically measured traffic and predicted traffic. Note that the measured traffic is used as supervised data that the traffic prediction model 322 learns.

FIG. 3A illustrates an exemplary relationship between measured traffic and predicted traffic in normal operation (in operation with no switch-off processing). As a cell configuration, small cells B and C are present inside a macro-cell A. Referring to FIG. 3A, at a time, the amount of measured traffic of the cell A is slightly larger than the respective amounts of measured traffic of the cells B and C that are close to each other. According to the predicted traffic output from the traffic prediction model 322 having learnt, as supervised data, the measured traffic, as illustrated in FIG. 3A, the amount of predicted traffic of the cell A is slightly larger than the respective amounts of predicted traffic of the cells B and C that are close to each other.

FIG. 3B illustrates an exemplary relationship between measured traffic and predicted traffic in operation with switch-off processing, in which base-station devices 200 that form cells B and C, respectively, are kept stopped. Although a cell configuration similar to that in FIG. 3A is provided, no radio waves are transmitted in the cells B and C. Thus, substantially no cells B and C are present. Referring to FIG. 3B, a cell A has a large amount of traffic. This is because of concentration of traffic in the cell A since substantially no cells B and C are present. Meanwhile, the respective amounts of traffic of the cells B and C are zero. According to the predicted traffic output from the traffic prediction model 322 having learnt, as supervised data, the measured traffic, as illustrated in FIG. 3B, the amount of predicted traffic of the cell A is larger than the respective amounts of predicted traffic of the cells B and C that are close to zero.

As above, in the communication system in which switch-off processing is performed, the traffic with some base-station devices 200 kept stopped has an influence on the traffic prediction model 322. Thus, for example, in a case where the predicted traffic in switch-off processing is used for determination of a base-station device 200 to be stopped, the cells B and C are determined as the stopping-target base station since the respective 20 amounts of traffic of the cells B and C are close to zero. As above, coexistence with the measured traffic in operation with switch-off processing causes traffic demand prediction regarding each cell to be difficult to perform. Thus, proper determination of the stopping-target base station may be difficult to perform.

Thus, in the first embodiment, with the predicted traffic per group, the server machine 300 determines the stopping-target base station.

### Switch-Off Processing

Switch-off processing will be described. For example, the switch-off processing is performed regularly or irregularly. The period during which the stopping-target base station is kept stopped is, for example, the period until the next switch-off processing is performed or a predetermined time (e.g., a previously set time or a time suitable to the traffic amount).

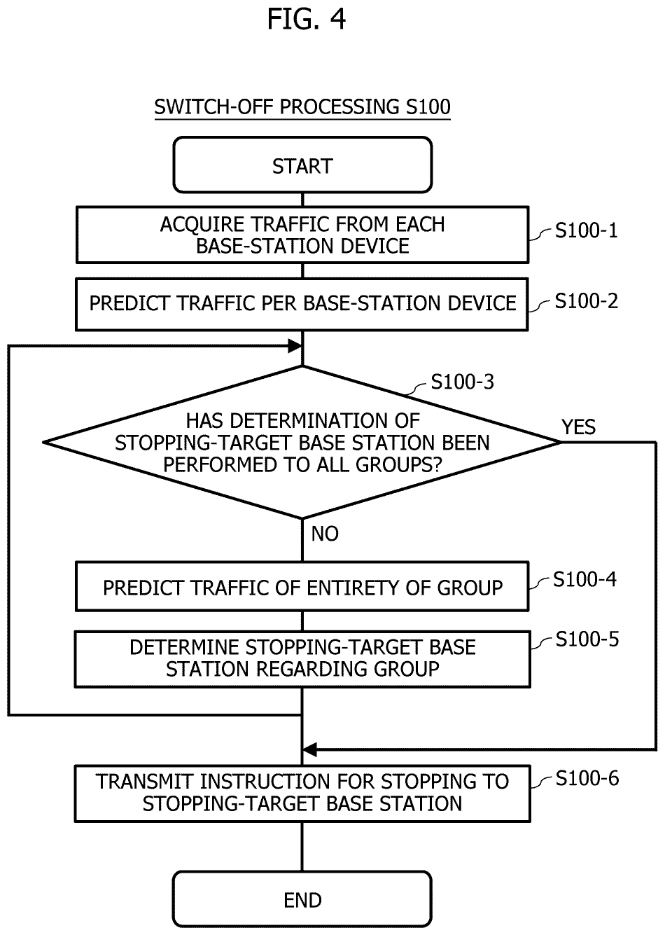

FIG. 4 illustrates an exemplary processing flowchart of switch-off processing S100. The server machine 300 acquires the traffic from each base-station device 200 (S100-1). With the acquired traffic, the server machine 300 causes the traffic prediction model 322 to learn.

The server machine 300 predicts the traffic of each base-station device 200 (individual traffic) (S100-2). For example, with the traffic prediction model 322, the server machine 300 predicts, on the basis of the latest traffic, the traffic after a predetermined time (at a predetermined time).

The server machine 300 verifies whether or not determination of the stopping-target base station has been performed to all the groups (including a group of a single base-station device 200) (S100-3).

In a case where any group to which determination of the stopping-target base station has not been performed yet is present (No in S100-3), the server machine 300 predicts the traffic of the entirety of a group (group traffic) (S100-4). Then, the server machine 300 determines the stopping-target base station regarding the group (S100-5). The server machine 300 repeats the steps of processing S100-4 and S100-5 until determination of the stopping-target base station is performed to all the groups.

Note that, as determination of the stopping-target base station, for example, it may be determined that any base-station device in the corresponding group is not allowed to stop. For example, in a group including a cell in which the amount of traffic is highly large, stopping some base-station devices 200 is likely to cause concentration of traffic in a base-station device 200 in operation, resulting in excess of the allowable number of terminal devices 100. Therefore, it may be determined that the group includes no stopping-target base station.

In a case where no group to which determination of the stopping-target base station has not been performed yet is present (Yes in S100-3), the server machine 300 transmits an instruction for stopping to the stopping-target base station (S100-6), followed by termination of the processing.

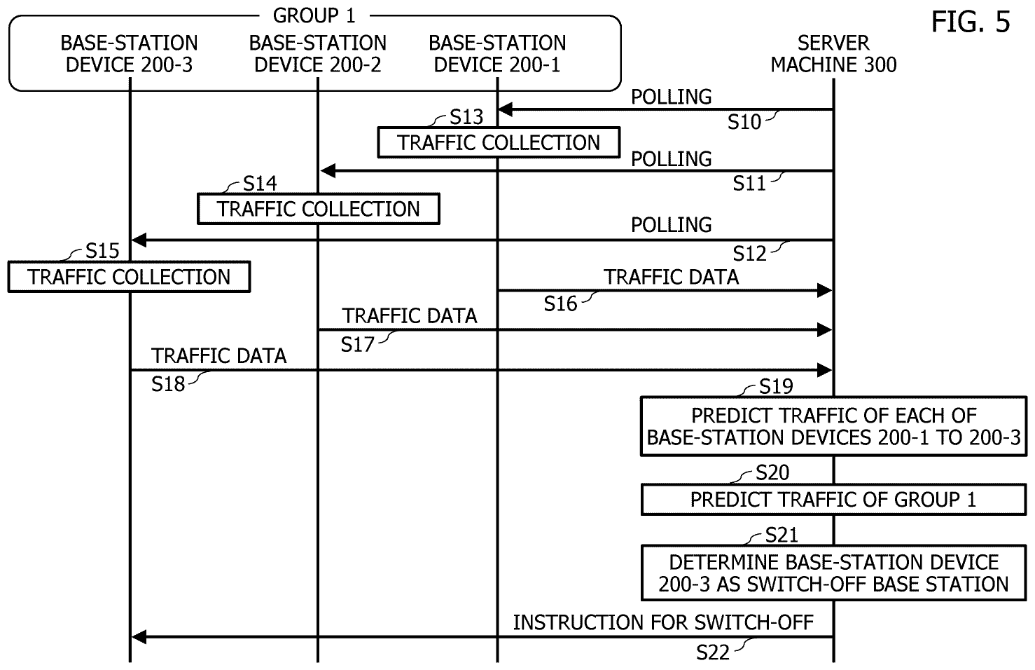

FIG. 5 illustrates an exemplary sequence of switch-off processing. The base-station devices 200-1 to 200-3 belong to the same Group 1.

For collection of traffic, the server machine 300 performs polling to the base-station devices 200-1 to 200-3 in Group 1 (S10 to S12).

In response to the polling, the base-station devices 200-1 to 200-3 each perform traffic collection (S13 to S15) and then transmit a collected result (traffic data) to the server machine 300 (S16 to S18).

The server machine 300 predicts the traffic of each of the base-station devices 200-1 to 200-3 (S19 corresponding to S100-2 in FIG. 4). Then, the server machine 300 performs traffic prediction of Group 1 (S20 corresponding to S100-4 in FIG. 4).

On the basis of the traffic prediction of Group 1, the server machine 300 determines the base-station device 200-3 as a base-station device to be switched off in Group 1 (S21 corresponding to S100-5 in FIG. 4).

The server machine 300 transmits an instruction for switch-off to the stopping-target base station (e.g., the base-station device 200-3) (S22 corresponding to S100-6 in FIG. 4). In response to the instruction for switch-off, the base-station device 200-3 stops the transmission and reception of radio waves.

### Group Classification

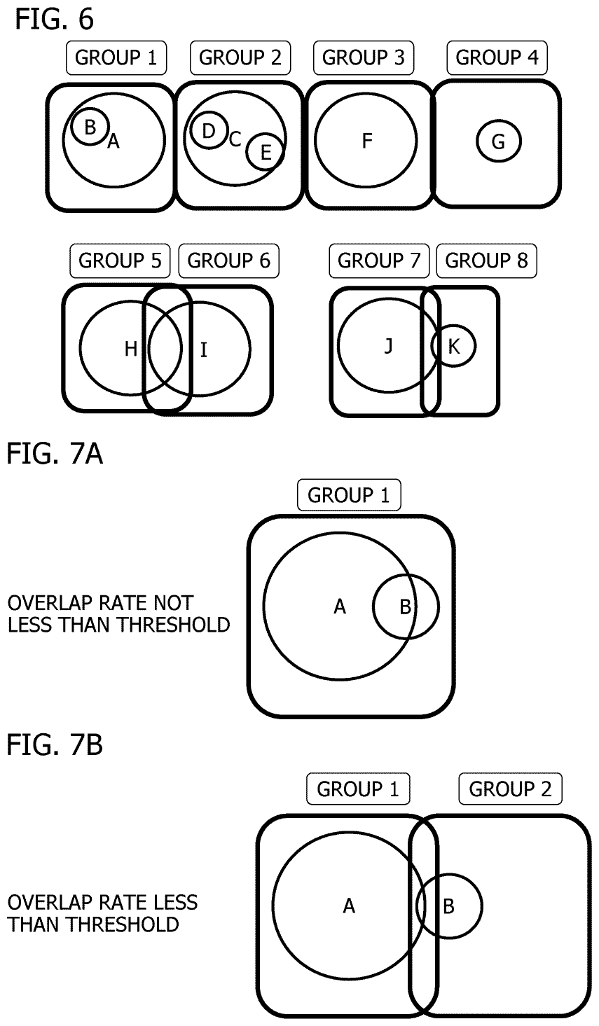

Group classification (grouping) will be described. FIG. 6 illustrates exemplary groups.

According to the group classification in FIG. 6, for example, one cell (base-station device 200) belongs to one group without belonging to a plurality of groups.

According to the group classification in FIG. 6, one group includes a macro-cell and a small cell of which the entire cell region is included in the region of the macro-cell.

Group 1 corresponds to a group of one macro-cell and one small cell. The entire region of a small cell B is completely included in the region of a macro-cell A.

Group 2 corresponds to a group of one macro-cell and two small cells (multiple small cells). The respective entire regions of small cells D and E are completely included in the region of a macro-cell C.

Group 3 corresponds to a group of one macro-cell. Group 4 corresponds to a group of one small cell. As above, in a case where no cells of which the respective regions overlap are present, one group of one cell is provided.

Groups 5 and 6 each correspond to a group in which a macro-cell has a partial region overlapped. Macro-cells H and I have respective partial regions overlapping but the region of one of the cells does not completely include the region of the other cell. Thus, the macro-cells H and I are classified into mutually different groups (that is, the macro-cells H and I are classified into Groups 5 and 6, respectively).

Groups 7 and 8 each correspond to a group in a case where a partial region of a small cell overlap the region of a macro-cell. A macro-cell J and a small cell K have respective partial regions overlapping but the region of the macro-cell does not completely include the region of the small cell. Thus, the macro-cell J and the small cell K are classified into mutually different groups (that is, the macro-cell J and the small cell K are classified into Groups 7 and 8, respectively).

Referring to FIG. 6, one group includes a macro-cell and a small cell of which the entire cell region is included in the region of the macro-cell. Instead of the entire cell region, even in a case where a predetermined proportion or more of the region overlap, the same group may be set.

FIGS. 7A and 7B illustrate exemplary groups. According to the group classification in FIGS. 7A and 7B, one group includes a macro-cell and a small cell of which a predetermined proportion or more of the region is included in the region of the macro-cell. Note that the proportion of the region of the small cell overlapping the region of the macro-cell to the entire region of the small cell is also referred to as an overlap rate. In addition, the threshold is, for example, 50%.

Referring to FIG. 7A, provided is Group 1 of one macro-cell and one small cell. 50% or more of a small cell B overlaps a macro-cell A, and thus the small cell B is classified into Group 1 into which the macro-cell A is classified.

On the other hand, referring to FIG. 7B, provided are Group 1 of one macro-cell and Group 2 of one small cell. Because approximately 10% of a small cell B overlaps a macro-cell A, its overlap rate is less than the threshold. Thus, the small cell B and the macro-cell A are classified into mutually different groups.

### Group Predicted Traffic

Group predicted traffic will be described. The group predicted traffic is, for example, the total (sum) of the amounts of traffic of the base-station devices 200 included in a group. For determination of the stopping-target base station, the server machine 300 sorts the group predicted traffic for the respective amounts of individual traffic of the base-station devices (for the respective amounts of corrected individual traffic).

As a sorting method, area ratios are calculated on the basis of the respective cell areas of the base-station devices 200 in a group and then sorting is performed to the base-station devices 200 in accordance with the area ratios. A higher area ratio causes a larger amount of traffic.

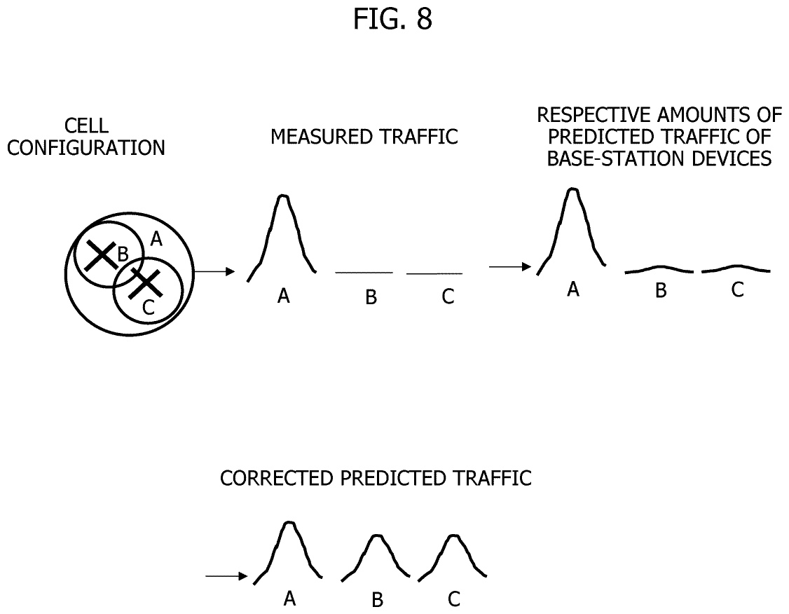

FIG. 8 illustrates exemplary group predicted traffic sorting. The server machine 300 sorts group predicted traffic that is the total of the respective amounts of predicted traffic of base-station devices 200, for example, on the basis of the area ratios, to obtain corrected traffic in FIG. 8. Thus, either a cell B or a cell C or both the cell B and the cell C are determined as the stopping-target base station.

The traffic of each base-station device 200 varies depending on the stopping-target base station. Thus, preferably determination of the stopping-target base station and traffic prediction of the base-station devices 200 are performed simultaneously or in parallel. For example, the server machine 300 may perform a wireless simulation to calculate the traffic of each base-station device 200, on the basis of the cell area ratios, from the group predicted traffic, determine the stopping-target base station, and allocate (correct) the traffic of the base-station device 200 kept stopped as an addition to the traffic of a base-station device in operation. Then, the server machine 300 may determine, as the stopping-target base station, a base-station device that does not have much influence on services even when kept stopped (base-station device that does not cause much deterioration in service quality or has no influence on services).

Note that, preferably, all the base-station devices 200 are verified in terms of stopping to determine an optimum stopping-target base station. Thus, optimum switch-off pattern learning with use of AI enables a reduction in computation time.

### OTHER EMBODIMENTS

For example, a cell and an overlap rate may be assumed and calculated as follows. Note that, in the following, without consideration of the directivity of radio waves, radio waves are emitted in all directions.

The radius of radio waves of a base-station device 200 is obtained. For example, the radius can be calculated by the Friis transmission equation with the height of the antenna, the frequency of radio waves, and the output of radio waves.

On the basis of the positional coordinates of the base-station device 200 and the radius of radio waves, the cell of the base-station device 200 is plotted on a plane to obtain an overlap with the region of the cell of another base-station device 200 (overlap rate). Note that an advanced radio-wave simulation taking buildings and topographical features into account enables obtainment of a more accurate coverage relationship.

Switch-off processing may be performed by a device different from the server machine 300. For example, a base-station device 200 that forms a macro-cell may perform switch-off processing.

According to a disclosure, traffic prediction can be performed with high accuracy in a wireless communication system in which switch-off processing is performed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A control device comprising:
a predictor that predicts group traffic of a group including a plurality of base-station devices, with use of respective amounts of individual traffic of the plurality of base-station devices; and
a controller that determines whether to stop or operate a base-station device in the group, in accordance with the predicted group traffic, wherein
the group includes a base-station device that forms a macro-cell and a base-station device that forms a small cell, and
the small cell includes a region overlapping the macro-cell.

2. The control device according to claim 1, wherein
an entire region of the small cell overlaps a region of the macro-cell.

3. The control device according to claim 1, wherein
a proportion of the region of the small cell overlapping the macro-cell to an entire region of the small cell is a first threshold or more.

4. The control device according to claim 1, wherein
the controller sums up the respective amounts of individual traffic of the plurality of base-station devices to calculate the group traffic.

5. The control device according to claim 1, wherein
the controller allocates the group traffic in accordance with areas of respective cells that the plurality of base-station devices form to calculate respective amounts of corrected individual traffic of the plurality of base-station devices.

6. The control device according to claim 1, wherein
the controller calculates, with use of the group traffic, respective amounts of individual traffic of the plurality of base-station devices, and
adds, as an addition, first individual traffic of a first base-station device that is a stopping target to second individual traffic of a second base-station device that is not a stopping target and determines whether to stop or operate a base-station device while taking the addition into account.

7. The control device according to claim 1, wherein
the group traffic is output from a learning model that has learnt respective amounts of measured traffic of the plurality of base-station devices and predicts the group traffic.

8. The control device according to claim 1, wherein
the controller controls the base-station device, which is a stopping target, to stop.

9. A base-station control method comprising:
predicting group traffic of a group including a plurality of base-station devices, with use of respective amounts of individual traffic of the plurality of base-station devices; and
determining whether to stop or operate a base-station device from among the plurality of base-station devices in the group, in accordance with the group traffic, wherein
the group includes a base-station device that forms a macro-cell and a base-station device that forms a small cell, and
the small cell includes a region overlapping the macro-cell.
